(19) United States
(12) Patent Application Publication
(10) Pub. No.: US 2022/0067735 A1
(43) Pub. Date: Mar. 3, 2022

(54) SYSTEMS AND METHODS FOR USE WITH NETWORK AUTHENTICATION

(71) Applicant: MASTERCARD INTERNATIONAL INCORPORATED, PURCHASE, NY (US)

(72) Inventor: Denise E. Tinnon, Manchester, MO (US)

(21) Appl. No.: 17/003,670

(22) Filed: Aug. 26, 2020

(51) Int. Cl. G06Q 20/40; G06Q 20/38; H04L 9/32

(52) U.S. Cl. CPC G06Q 20/4014; H04L 9/3213; G06Q 20/382

(57) ABSTRACT

Systems and methods are provided for sharing personal identifying information with relying parties. One exemplary computer-implemented method includes generating a token for personal identifying information (PII) included in a record of a user and linking the token to the record. The method then includes, in response to a request for the token, accessing the record, authenticating the user, compiling a response to the request that includes the token, and transmitting the response to a communication device of the user, whereby the token included in the response is populated, at the communication device, into an interface associated with a relying party based on a network interaction between the user and the relying party. The method further includes, in response to a request for the PII from the relying party, retrieving the PII for the user based on the token included in the request and transmitting the PII to the relying party.

### FIELD

The present disclosure is generally directed to systems and methods for use with network authentication, whereby encrypted tokens may be employed in lieu of identifying information (e.g., instead of personal identifying information, etc.).

### BACKGROUND

This section provides background information related to the present disclosure which is not necessarily prior art.

Users are known to rely on their identities to interact with a variety of different parties, whereby the parties then rely on the identity (i.e., a relying party) when interacting with the users (e.g., when establishing new accounts, etc.). When the users present their identities, in connection with such interactions, the parties are known to authenticate the users in person by photo IDs or other physical documents, or by witnesses, or electronically (e.g., based on usernames, passwords, biometrics, etc.), in order to confirm, with a desired degree of certainty, that the users are in fact associated with the identities. When the authentication is successful, the users are permitted to proceed in the interactions with the parties, and the parties may then rely on the identities of the users.

### DRAWINGS

The drawings described herein are for illustrative purposes only of selected embodiments and not all possible implementations, and are not intended to limit the scope of the present disclosure.

FIG. 1 illustrates an exemplary system of the present disclosure for disseminating tokens to relying parties to permit the relying parties to retrieve identifying information for users, in lieu of disseminating the identifying information for the users directly to the relying parties;

FIG. 2 is a block diagram of a computing device that may be used in the exemplary system of FIG. 1; and

FIG. 3 illustrates an exemplary method, which may be implemented in connection with the system of FIG. 1, for disseminating a token to a relying party, in lieu of identifying information associated with a user, whereby the token then permits the relying party to retrieve the identifying information for the user.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Users are associated with identities, to which the users are often authenticated by relying parties in connection with various activities, such as, for example, requesting or directing services (e.g., ride share services, healthcare services, travel services, telecommunication services, etc.), establishing accounts (e.g., bank accounts, retirement accounts, email accounts, etc.), etc. The identities in turn include various personal identifying information (PII) for the users. In connection therewith, theft of such identities (and the corresponding PII) may be a concern, for example, via data breaches at relying party locations, via viruses on user computing devices (that may take screen grabs and thereby obtain PII for the users), via physical thieves (e.g., instances where users are in public areas and thieves watch the users enter PII to their computing devices and thereby capture the same, etc.), etc.

Uniquely, the systems and methods herein permit users to share their PII with the relying parties through tokens provided to the relying parties (instead of directly providing their PII to the relying parties), by way of an identity provider (IDP) housing the PII, where the tokens may then be used by the relying parties to validate the identities of the users or to retrieve PII linked to the tokens. In particular, a user may cooperate with the IDP to generate an identity record for the user based on his/her PII. Then, when the user interacts with a relying party, the user may opt to share PII with the relying party through the IDP by way of a token, by selecting a secure share option at an interface provided by the relying party (e.g., an application form for an account, etc.). Upon selection, the IDP, through an SDK integrated by the relying party (or otherwise) at the interface, authenticates the user and provides the token, specific to the user's PII requested, to the interface. Upon receipt of the token, the relying party submits the token to the IDP, to either validate the identity of the user or to retrieve the PII for the user. In either instance, the relying party, upon receipt of the validation or the PII, is permitted to continue interacting with the user (e.g., to issue a new account, etc.), whereby the relying party is able to identify the user by way of the token without the user actually passing PII to the relying party through the interface connection (or otherwise) between the user and the relying party. In this manner, users are able to share as little PII as possible directly with relying parties (e.g., via interface connections with the relying parties, etc.), but can still achieve desired interactions with the relying parties through use of the tokens to validate their identifies. In so doing, identity theft may be limited, reduced, and or eliminated in connection with such interactions. In addition, security associated with the sharing of PII is enhanced in a network sharing scheme associated with the interactions between the relying party and the user.

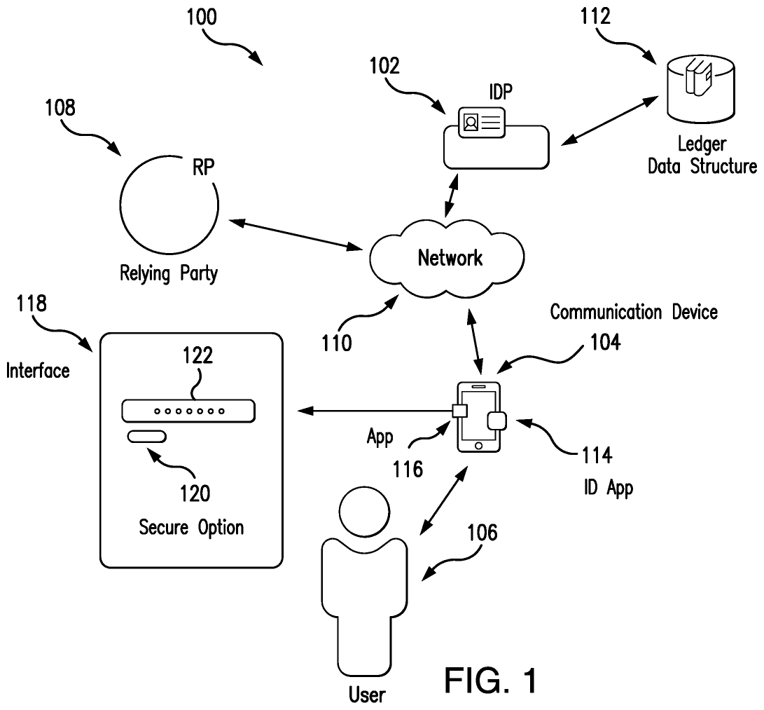

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, relationships between users and relying parties, platforms utilized for identity services, privacy concerns and/or requirements, etc.

The illustrated system 100 generally includes an identity provider (IDP) 102, a communication device 104 associated with a user 106, and a relying party 108, each of which is coupled to network 110. The network 110 may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. Further, in various implementations, the network 110 may include multiple different networks, where one or more of the multiple different networks are then accessible to particular ones of the IDP 102, the communication device 104, and/or the relying party 108.

The IDP 102 in the system 100 generally is associated with forming and/or managing digital identities associated with users (e.g., user 106, etc.). In connection therewith, the IDP 102 is configured to participate in registering, provisioning, and storing (in secure memory of a computing device associated with the IDP 102 (e.g., in a secure portion of memory 204 described below, etc.)) identity information associated with the users which may be provided to one or more relying parties, as required (such as relying party 108). In connection with storing the identity information associated with the users, such information may be stored in a Trusted Execution Environment (TEE) associated with the IDP 102. In addition (or alternatively), in some embodiments, the identity information may be stored locally at the communication device 104 (e.g., in a secure element associated therewith (e.g., in a secure element (e.g., a TEE, etc.) in memory of the communication device 104, etc.), etc.). In general, though, when a digital identity is provided to the relying party 108, for a user, from the IDP 102 (or from the user's communication device 104), the relying party 108 is permitted to trust the digital identity, thereby relying on the authentication and provisioning processes of the IDP 102.

The communication device 104 may include, for example, a portable communication device such as a tablet, a smartphone, a personal computer, etc. In addition, the communication device 104 includes one or more network-based applications, including ID application (ID App) 114 associated with the IDP 102. The ID application 114 configures the communication device 104 to interact with the IDP 102. In connecting therewith, the user 106 may register an identity with the IDP 102 through use of the application 114 at the communication device 104. In particular, when the ID application 114 is downloaded and activates in the communication device 104, the communication device 104, as configured by the ID application 114, solicits personal identifying information (PII) from the user 106. In response, the user 106 provides the solicited personal identifying information to the communication device 104, as configured by the ID application 114. In turn, the communication device 104, as configured by the ID application 114, transmits the personal identifying information to the IDP 102. The personal identifying information may include, for example, a name of the user 106, an email address, a mailing address, a phone number, a government ID number (e.g., a social security number, a driver's license number, etc.), a birthdate, a gender, a birth place, etc.

In response to the PII, the IDP 102 is configured to generate an identity record for the user 106 and to store the identity record in a ledger data structure 112 (in secure memory associated therewith). The IDP 102 may also be configured to include identification information for the user's communication device 104 in the identity record (e.g., a MAC address, etc.) as well as reference authentication data for use in subsequently authenticating the user 106 in connection with requests for PII included in the identity record. That said, the data structure 112 may include a memory associated with or included in the IDP 102 (e.g., in a computing device associated with the IDP 102, etc.), or the data structure 112 may be separate from the IDP 102 and/or associated with another entity, etc.

Furthermore, during registration of an identity, the user 106 may select an option (or options) to permit or limit sharing of PII with relying parties (e.g., set permissions, etc.), such as, for example, the relying party 108. In one example, the user 106 may opt to share a government ID number with the relying party 108, while in another example, the user 106 may opt to only validate a token for the relying party 108. Further, such limitations may be set by the user 106 for specific relying parties (on a relying party by relying party basis), or such limitations may be set broadly for all relying parties or for particular categories of relying parties or for particular uses by relying parties, etc. For instance, the user 106 may select to only share PII from his/her identity record with parties for non-banking and non-credit card account activities. As such, if an entity or party attempts to gain access to the user's identity record at the ledger data structure 112 to open a credit card or bank account, the entity or party would not be allowed access to the user's PII. In so doing, in setting up the user's identity record, the IDP 102 may display a list of check-boxes that allow the user 106 to establish the desired permissions, whereby such permissions are then configurable (i.e., can be updated or changed) throughout the lifecycle of the existence of user's record with the IDP 102. In any case, the option(s) to share, validate, etc. are stored, by the IDP 102, as part of the identity record for the user 106.

What's more, during registration (or thereafter), the IDP 102 is configured to generate one or more tokens for the user 106 and/or the user's PII, which are then linked to the content of the user's identity record (thereby minimizing or eliminating potential exposure of the user's PII to any applications, etc. at the communication device 104 requesting the PII, by way of using the token(s) instead). For example, a token may be generated for the user's government ID number, which may, for example, include the same format as the government ID number, or not. In general, then, the user's PII is not derivable from the token. In connection therewith, the token may include numbers, letters, special characters, or a combination of numbers and/or letters and/or special characters (e.g., randomly generated, etc.). Additionally, the token may include single or multi-use tokens, cryptographic or non-cryptographic tokens, reversible or irreversible tokens, authenticable or non-authenticable tokens, combinations thereof, etc. The token may further be associated with an expiration date (e.g., a few seconds, a few minutes, a few days, etc.), whereby the token is only valid for a limited time, during a period up to the expiration date (e.g., such that the token may be a limited time token or limited use token, etc.).

It should be appreciated that a token may be generated for each piece of the user's PII, or for groups of the PII (e.g., a group including the user's name, address and phone number; etc.), or for the PII for the user's identity record in total. It should further be appreciated that the tokens may be generated when the identity record is generated and stored, or at other times, depending, for example, on the implementation of the IDP 102, etc. When generated, though, the IDP 102 is configured to store the tokens in connection with (and/or linked to) the user's identity record (and/or particular PII therein) (e.g., in the ledger data structure 112 (in secure memory associated therewith), etc.), or as part thereof (whereby the token(s) may be included in the identity record as a part thereof), to enable one or more of the operations described herein.

In addition in the system 100, the communication device 104 also includes a network-based application 116, which is associated with the relying party 108. The application 116 may include an application installed and active in the communication device 104, or it may relate to a website accessed via a web browser included in the communication device 104, or it may relate to any interface or series of interfaces accessible at the communication device 104 and related to an interaction with the relying party 108, or otherwise. In either case, the application 116 configures the communication device 104 to be able to interact with the relying party 108. For example, where the application 116 includes a website provided by the relying party 108 and accessed via a web browser at the communication device 104, the user 106 may interact with the website to provide PII to the relying party 108 to apply for an account (e.g., a bank account, etc.), etc.

In this exemplary embodiment, the application 116 includes a software development kit (SDK) associated with the IDP 102. The SDK configures the application 116, and by extension, the communication device 104, to further interact with the IDP 102. Specifically, when the application 116 is accessed at the communication device 104, one or more interfaces are displayed to the user 106 at the communication device 104, depending on the interaction with the relying party 108. When, for example, the user 106 is attempting to create a new account, interface 118 may be displayed to the user 106 at the communication device 104. In connection therewith, the interface 118 may include a field 122 to solicit PII from the user 106, for example, as a requirement to establish a new account, access an existing account, etc. The solicited PII may include, again, a name of the user 106, a mailing address, an email address, a phone number, a government ID number, etc. In addition, the interface 118 integrates a secure populate option 120 with regard to the user's PII, which is provided by the SDK of the IDP 102 to implement the features described herein.

It should be appreciated that while only one field 122 is shown in the interface 118 in the illustrated embodiment (for simplicity), interfaces will often include a number of different fields soliciting different PII (e.g., where each field potentially requests a different PII for the user 106 (e.g., a date of birth, a government ID number, etc.), etc.), whereby the secure populate option 120 may apply to one or more of the fields together, or where each of the fields may include a secure populate option.

In general, in response to the interface 118, for example, the user 106 may enter the requested PII into the field 122, whereby the communication device 104, as configured by the application 116, returns the PII to the relying party 108. Alternatively, in accordance with the present disclosure, the user 106 may select the secure populate option 120, wherein the communication device 104, as configured by the SDK of the application 116, opens a lightbox interface on top of the interface 118 (not shown) and solicits, by the lightbox interface, an authentication input from the user 106 (e.g., a PIN, a passcode, a biometric, etc.). When the user 106 provides the authentication input to the lightbox interface, the communication device 104, as configured by the SDK of the application 116 (e.g., via an application programming interface (API) call to the IDP 102, etc.), then submits the authentication input to the IDP 102, along with a field description of the PII required by the interface 118 for the field 122, as a request for a secure token. In connection therewith, the field description (and specific PII required by the field 122) may be coded into the field 122, and the SDK may then read the description (and required PII) from the code. The field description, then, may indicate the type of information to be filled into the field 122 of the interface 118. For example, the field 122 may require a social security number, whereby the field description (associated with the request for the secure token) may indicate “SSN.”

Upon receipt, the IDP 102 is configured to identify the user 106 based on the communication device 104 (e.g., based on a MAC address for the communication device 104 included in the submission from the communication device 104 to the IDP 102, etc.). The IDP 102 is configured to then authenticate the user 106, based on the authentication input (e.g., by comparison to a reference stored in the identity record for the user 106, etc.) and, when authenticated, to generate or retrieve a token based on the field description. The IDP 102 is configured to return the token to the communication device 104. In turn, the communication device 104, as configured by the SDK of the application 116, closes the lightbox interface and populates the token in the field 122 of the interface 118. As shown in FIG. 1, the token is obfuscated within the field 122, in this embodiment (as indicated by the seven dots), such that the user 106 is unable to see or understand the token. By obfuscating the token, the user 106 is inhibited from writing down the token or otherwise recording it or otherwise displaying it, whereby others could potentially steal the token and/or use it in an unauthorized manner to access and/or utilize the user's PII (and corresponding identity). Similarly, this also hides the token from any virus or nefarious program on the user's communication device 104 that may take screen grabs/screenshots from the device 104, thereby also inhibiting the screen grabs/screenshots from obtaining the token and any usable PII associated with the token. In other embodiments, however, the token may be seen or understood by the user 106. Thereafter, in either case, the user 106 is permitted to submit the token along with other PII to the relying party 108 (either tokenized or not), whereby the communication device 104, as configured by the application 116, encrypts and transmits the token and/or the PII to the relying party 108 as included in the field 122.

In turn, when the relying party 108 receives the data from the communication device 104, the relying party 108 is configured to decrypt the token and/or the PII, as needed. When the token is submitted to the relying party 108 via the interface 118, the relying party 108 is configured to then submit the token to the IDP 102, when included, in order to validate the user 106 or to retrieve the PII linked to the token, which, in this example, is the user's social security number. Next, the IDP 102 is configured to access the identity record for the user 106 from the ledger data structure 112, based on (and as identified by) the token, and verify that the token is consistent with a token generated for the user 106. And, when verified, the IDP 102 is configured to either transmit a validation of PII to the relying party 108 for the user 106 (i.e., that the token is in fact associated with the user 106 and that by way of receiving the token from the relying party 108, the user's PII is thereby confirmed), or to retrieve the actual PII associated with the token and to transmit the retrieved PII to the relying party 108. In some embodiments, prior to transmitting the validation of PII or the retrieved PII to the relying party 108, the IDP 102 may first authenticate the relying party 108 as being registered to the IDP 102 and/or an authorized party to received such data from the IDP 102, for example, based on any permissions or limitations set by the user 106 for the particular PII being validated and/or retrieved or based on inclusion of the SDK associated with the IDP 102 in the application 116 of the relying party 108. The IDP 102 may then also further confirm any additional permissions or limitations set by the user with respect to the sharing of the PII with the relying party 108.

Regardless, the relying party 108 is configured to continue in the interaction with the user 106, based on the validation (and/or retrieval) of the PII. For example, the relying party 108 may be configured to open an account for the user 106 consistent with the PII received from the user 106 and/or the IDP 102 (or validated by the IDP 102), etc. When the relying party 108 includes a banking institution, for example, the account issued by the relying party 108 may include a checking account, or savings account or other financial account, etc.

While only one IDP 102, one communication device 104, one user 106, and one relying party 108 are illustrated in the system 100, it should be appreciated that additional ones of these parts may be included in other system embodiments. Specifically, for example, it should be appreciated that other system embodiments may include multiple users, each having various different relying party applications, etc.

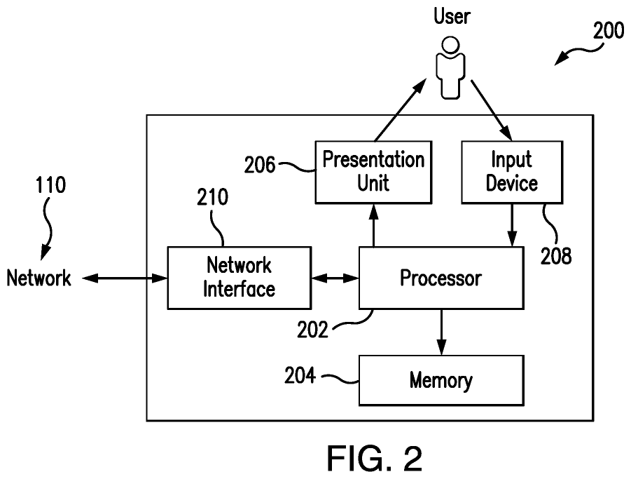

FIG. 2 illustrates an exemplary computing device 200 that can be used in the system 100 of FIG. 1. The computing device 200 may include, for example, one or more servers, workstations, personal computers, laptops, tablets, smartphones, etc., or any other suitable physical or virtual machine; etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the IDP 102, the communication device 104, the relying party 108, and the ledger data structure 112 may be considered, may include, and/or may be implemented in a computing device consistent with the computing device 200, coupled to (and in communication with) the network 110. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may include secure memory and/or one or more TEEs, and may be configured to store, without limitation, PII, tokens, identity records, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein (e.g., one or more of the operations of method 300, etc.), whereby through such performance (or operation) the computing device 200 may be transformed into a special purpose computing device. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., prompts to the user 106 at the communication device 104 for an authentication input, etc.), etc. And, various interfaces (e.g., as defined by the applications 114 and 116, etc.) may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) of the computing device 200 such as, for example, selection of a secure option, authentication inputs, etc., in response to prompts from one or more interfaces, etc., as further described below. The input device 208 may include a single input device or multiple input devices. The input device 208 is coupled to (and is in communication with) the processor 202 and may include, for example, one or more of a keyboard, a pointing device, a mouse, a camera, a touch sensitive panel (e.g., a touch pad or a touch screen, etc.), another computing device, and/or an audio input device. In various exemplary embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth™ adapter, etc.), a mobile network adapter, or other device capable of communicating to one or more different networks herein (e.g., network 110, etc.) and/or with other devices described herein. Further, in some exemplary embodiments, the computing device 200 may include the processor 202 and one or more network interfaces incorporated into or with the processor 202.

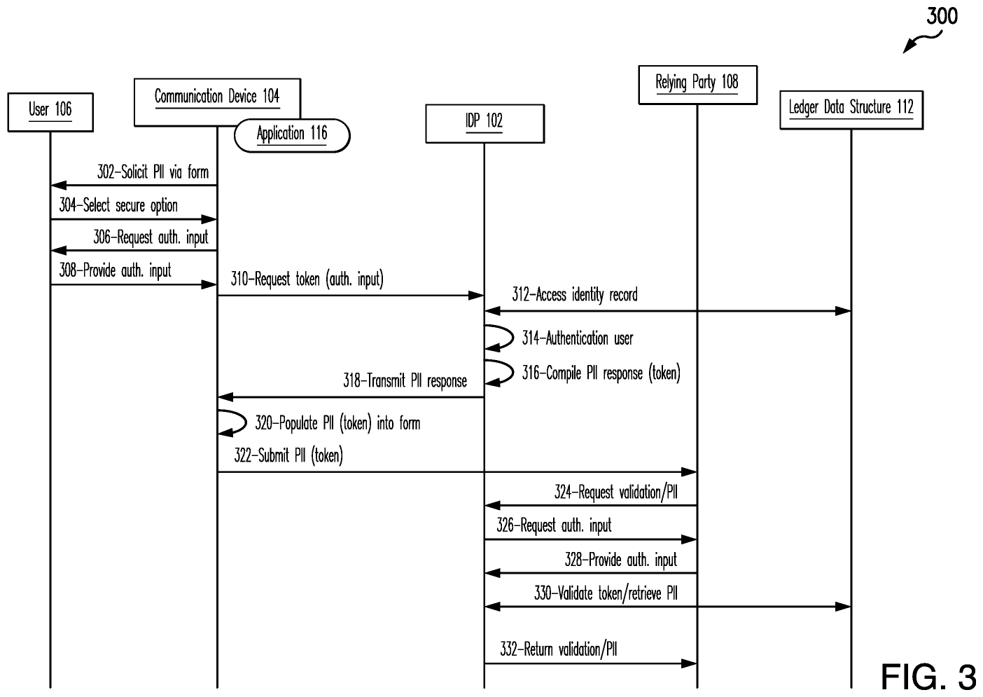

FIG. 3 illustrates an exemplary method 300 for use in sharing personal identifying information or PII. The exemplary method 300 is described as implemented in the system 100, with reference to the IDP 102, the communication device 104, and the relying party 108, and with additional reference to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

Initially, it should be appreciated that the user 106 is registered with the IDP 102, whereby an identity record for the user 106 is stored in the ledger data structure 112. The identity record includes different PII associated with the user 106, including, without limitation, a name, an address, a phone number, an email address, a government ID number (e.g., a social security number, a driver's license number, etc.), etc. In addition, in this exemplary embodiment, the user 106 has opted to share his/her government ID number (specifically, his/her social security number). The identity record for the user 106 also includes a token or virtual social security number (vSSN), which is linked to the user's real social security number (rSSN) in the identity record. None of the other PII in the identity record for the user 106 is associated with the vSSN, but the user 106 may decide, at a later time, to include other tokens in the identity record, linked to other PII.

That said, in the method 300, the user 106 decides to apply for a financial account (e.g., checking account, a savings account, a payment account, etc.) with the relying party 108, which is then a banking institution in this example. As such, the user 106 has downloaded and activated the application 116 at the communication device 104, where the application 116 is published by the relying party 108 in this example as a banking application. As such, in applying for the financial account, the user 106 accesses the application 116, at the communication device 104 (via one or more login credentials and/or authentication inputs), and selects to apply for the financial account.

In response, the communication device 104 solicits, at 302, PII from the user 106, via a form, which may include one or more interfaces (such as the interface 118, etc.). In general, the form will include fields for the user 106 to fill in his/her name, address, phone number, etc. Additionally, the form, or one of the interfaces thereof, will include a secure option associated with one or more of the fields (such as the secure option 120), for example, the social security number field. It should be appreciated that other fields may also be provided with a secure option (associated with the IDP 102) to facilitate securely providing PII to the relying party 108 as described herein.

In filling in the form, via the application 116, the user 106 selects, at 304, the secure option for providing his/her social security number to the relying party 108. When the secure option is selected, the SDK of the application 116 is called, whereby the communication device 104 solicits, at 306, an authentication input from the user 106, at the communication device 104. In particular, the SDK causes a lightbox interface (i.e., as used in JavaScript) (or other suitable interface) to overlay on the form (or interface). The lightbox interface, then, includes an instruction to enter an authentication input, which may include a PIN, passcode, password, passphrase, etc. keyed into a field of the lightbox interface, or a biometric captured via an input device (e.g., via input 208, etc.) of the communication device 104 (e.g., a camera, a fingerprint scanner, etc.), or other input by the user 106, etc.

In response, the user 106 provides, at 308, the authentication input to the lightbox interface, and more generally, to the communication device 104. In turn, the communication device 104 requests, at 310, a secure token from the IDP 102, and in particular in this example, a secure token representative of the social security number for the user 106. The request may include a device ID associated with the communication device 104 (e.g., a MAC address, etc.), an application ID of the application 116 (or the application 114), PII entered by the user 106 into the form, etc., along with the authentication input provided by the user 106 to the communication device 104 and a description or designation of the PII being requested. It should be appreciated that the request may be encrypted prior to being transmitted to the IDP 102, for example, via a certificate or key pair included in the SDK, etc.

Optionally, in providing the authentication input, the SDK of the application 116 may wake the ID application 114, whereupon the ID application 114 authenticates the user 106 at the communication device 104, for example, based on a biometric captured from the user 106 (i.e., the authentication input) and a biometric reference provisioned to the communication device 104 during registration. When authenticated, the ID application 114 may then hand an authentication result (e.g., as signed by the ID application 114, or provided with a public key, etc.) back to the application 116 as an authentication input to include in the request for PII.

In either case, the IDP 102, in turn, receives the request and identifies the user 106 based on, for example, the device ID for the communication device 104 matching a reference device ID included in the user's identity record (as provided to the IDP 102 by the user 106 upon establishing the identity record, etc.), the content of the authentication input matching a reference included in the user's identity record (as provided to the IDP 102 by the user 106 upon establishing the identity record, etc.), the user's name, the user's address, the user's phone number, the application ID of the application 116 (or the application 114), etc. The IDP 102 then accesses, at 312, the identity record for the user 106 at the ledger data structure 112. Once accessed, the IDP 102 authenticates, at 314, the user 106, based on the authentication input (if the user 106 was not already authenticated at the communication device 104 or in addition thereto). For instance, when the authentication input is a PIN or passcode, the IDP 102 may compare the input to a PIN or passcode included in the identity record. When the authentication input is a biometric, the IDP 102 may compare the biometric (or biometric template, as received from the communication device 104), to a biometric reference included in the identity record. Or, when the authentication input includes an authentication result (based on prior authentication of the user 106 at the communication device 104), the IDP 102 may validate the authentication result (e.g., by verification of the signature on the result, or a key associated with the result, etc.).

When authenticated, the IDP 102 compiles, at 316, the PII requested, as represented by a linked token stored in the identity record. Here, the IDP 102 compiles the vSSN into a PII response. The IDP 102 then transmits, at 318, the PII response, including the vSSN, to the communication device 104. It should be appreciated that, as above, the PII response may be encrypted in the same manner applied above to enhance security of the PII response transmitted to the communication device 104.

In some embodiments, the IDP 102 may also generate a token for the PII upon receipt of the request for the PII, or upon receipt of each request for the PII, such that the token may not be stored in the identity record until after the request for the PII is received. In such embodiments, the token may further include a limited time interval in the identity record, whereby it is deleted after five minutes, ten minutes, thirty minutes, an hour, or more or less, etc. In this manner, the token may include a limited life, thereby further enhancing security of the PII linked to the particular token.

Regardless, upon receipt of the token, the communication device 104, or more specifically, the SDK and application 116, cooperate to populate, at 320, the vSSN (broadly, token) into the social security number field of the form. It should be appreciated that the vSSN may simply be appended to the field and visible to the user 106, or the vSSN may be obscured, such that the vSSN is not apparent to the user 106. For example, as shown in FIG. 1, the vSSN may be represented by asterisks, dots, or other generic characters. And, after the vSSN is populated into the form, and other fields of the form are completed, as needed or desired, the PII included in the form, including the vSSN, is submitted, at 322, to the relying party 108 in response to a submit command from the user 106 (e.g., in response to a selection of a “Submit” button, etc.).

Upon receipt of the PII, the relying party 108 identifies the vSSN as being a token, based on a designation of such, by the application 116, and based on the use of the secure option. As such, at 324, the relying party 108 requests either validation of the user 106 from the IDP 102 or retrieval of the linked PII from the IDP 102. Here, because the token is a vSSN, the relying party request the rSSN linked to the vSSN. In response, the IDP 102 requests an authentication input from the relying party 108, at 326. The relying party 108, in turn, provides, at 328, an authentication input. The authentication input, like above, may include a username and password, a PIN, a passcode, or even a biometric associated with a user at the relying party 108 (e.g., an employee, manager, etc.).

When authenticated, the IDP 102 again accesses the identity record, in the data structure 112, and, at 330, validates the token received from the relying party 108 or retrieves the requested PII. In this example, the IDP 102 retrieves the rSSN for the user 106 based on the vSSN included in the request. The IDP 102 then returns, at 332, the rSSN (broadly, PII) to the relying party 108 (or otherwise validates the user 106 to the relying party 108). Thereafter, the relying party 108 is permitted to proceed in the application process with the user 106, relying on the rSSN, and potentially, issue the requested financial account to the user 106. It should be appreciated that any different PII may be provided to the relying party 108 in this manner, whereby the PII is not provided directly from the user 106 to the relying party 108 over a network connection that may, or may not be secure. As such, enhanced security is provided for the user's PII, and in sharing such PII with the relying party, through the description herein.

In view of the above, the systems and methods herein address electronic identity theft by using, in an unconventional manner, tokens to represent PII. In this way, PII for users, in connection with network interactions (in particular, network interactions involving users' mobile devices), may be obfuscated when transmitted electronically as part of the interactions. Such use of tokens goes beyond current levels of encryption typically used when transmitting PII as part of a network interaction (e.g., beyond current HTTPS technology, etc.) in that, even if the tokens are decrypted, they are still only representations of the actual PII. The decrypted token is not the PII itself.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) generating an identity record for a user and storing the identity record in a data structure, the identity record including personal identifying information (PII) for the user; (b) generating a token specific to the PII included in the identity record for the user and linking the token to the identity record in the data structure; (c) in response to a request for the token from a communication device associated with the user, accessing, by a computing device, the identity record for the user in the data structure, the request including an authentication input for the user captured by the communication device; (d) authenticating, by the computing device, the user based on the accessed identity record and the authentication input included in the request; (e) after authentication of the user, compiling, by the computing device, a response to the request that includes the token; (f) transmitting, by the computing device, the response to the communication device associated with the user, whereby the token included in the response is populated, at the communication device, into an interface associated with a relying party based on a network interaction between the user and the relying party; (g) in response to a request for the PII from the relying party, retrieving, by the computing device, the PII for the user, based on inclusion of the token in the request from the relying party, and transmitting the retrieved PII to the relying party; (h) identifying, by the computing device, the identity record for the user in the data structure, in response to the request for the token, based on an identifier included in the request for the token; (i) identifying the token within the identity record based on a field description included in the request for the token; and (j) authenticating the relying party, in response to the request for the PII from the relying party, prior to transmitting the retrieved PII to the relying party.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in sharing personal identifying information with a relying party, the method comprising:
generating an identity record for a user and storing the identity record in a data structure, the identity record including personal identifying information (PII) for the user;
generating a token specific to the PII included in the identity record for the user and linking the token to the identity record in the data structure;
in response to a request for the token from a communication device associated with the user, accessing, by a computing device, the identity record for the user in the data structure, the request including an authentication input for the user captured by the communication device;
authenticating, by the computing device, the user based on the accessed identity record and the authentication input included in the request;
after authentication of the user, compiling, by the computing device, a response to the request that includes the token;
transmitting, by the computing device, the response to the communication device associated with the user, whereby the token included in the response is populated, at the communication device, into an interface associated with a relying party based on a network interaction between the user and the relying party; and
in response to a request for the PII from the relying party, retrieving, by the computing device, the PII for the user, based on inclusion of the token in the request from the relying party, and transmitting the retrieved PII to the relying party.

2. The computer-implemented method of claim 1, wherein the token is further linked to the PII in the identity record; and
wherein the identity record includes additional PII that is not linked to the token.

3. The computer-implemented method of claim 1, further comprising identifying, by the computing device, the identity record for the user in the data structure, in response to the request for the token, based on an identifier included in the request for the token.

4. The computer-implemented method of claim 1, further comprising identifying the token within the identity record based on a field description included in the request for the token, the field description associated with a field of the interface associated with the relying party and soliciting the PII; and
wherein the PII is consistent with the field description.

5. The computer-implemented method of claim 1, wherein the request for the token includes an identification of the PII for which the token is to be generated; and
wherein generating the token specific to the PII includes generating the token specific to the PII in response to the request for the token, whereby the token is generated based on the identification of the PII included in the request for the token.

6. The computer-implemented method of claim 5, wherein the interface associated with the relying party includes a field associated with the identification of the PII for which the token is to be generated, whereby the request for the PII includes the identification of the PII; and
wherein the request for the PII is based on an interaction by the user with the field of the interface associated with the relying party.

7. The computer-implemented method of claim 1, further comprising authenticating the relying party, in response to the request for the PII from the relying party, prior to transmitting the retrieved PII to the relying party.

8. The computer-implemented method of claim 1, wherein the token includes a virtual government ID number; and
wherein the response to the request for the PII from the relying party includes a real government ID number for the user.

9. The computer-implemented method of claim 1, wherein linking the token to the identity record in the data structure includes storing the token in the identity record in the data structure.

10. A system for use in sharing personal identifying information with a relying party, the system comprising an identity provider computing device configured to:
generate a token specific to personal identifying information (PII) included in an identity record for a user and link the token to the identity record in a data structure associated with the identity provider computing device;
receive a request for the token from a communication device associated with the user;
in response to the request, access the identity record for the user in the data structure based on an identifier for the user included in the request, the request including an authentication input for the user captured by the communication device;
authenticate the user based on the accessed identity record and the authentication input included in the request;
in response to authentication of the user, retrieve the token linked to the identity record and append the token to a response to the request;
transmit the response to the communication device associated with the user, whereby the token appended to the response is populated, at the communication device, into an interface associated with a relying party in connection with a network interaction between the user and the relying party;
receive a request for the PII from the relying party, wherein the request includes the token, and validate the token for the PII included in the identity record of the user; and
in response to validation of the token, transmit a validation indication to the relying party for the PII based on validation of the token or transmit the PII to the relying party.

11. The system of claim 10, wherein the identity provider computing device is further configured to identify the identity record for the user in the data structure, in response to the request for the token, based on the identifier for the user included in the request for the token.

12. The system of claim 11, wherein the identity provider computing device is further configured to identify the token within the identity record based on a field description included in the request for the token, the field description associated with a field of the interface associated with the relying party and soliciting the PII.

13. The system of claim 10, wherein the identity provider computing device is further configured to authenticate the relying party, in response to the request for the PII from the relying party, prior to transmitting the retrieved PII to the relying party.

14. The system of claim 10, further comprising a non-transitory computer-readable storage medium comprising computer-executable instructions, which when executed by at least one processor of the communication device associated with the user, cause the at least one processor to:
display the interface associated with the relying party to the user; and
transmit the request for the token to the identity provider computing device in response to an input by the user at the interface.

15. The system of claim 14, wherein the computer-executable instructions, when executed by at least one processor of the communication device, further cause the at least one processor to:
receive the token from the identity provider computing device; and
populate the token into the interface associated with the relying party instead of providing the PII to the interface.

16. The system of claim 10, wherein the interface associated with the relying party includes a field soliciting the PII, and wherein the field includes a field description for the PII, whereby the request for the PII includes the field description for the PII from the field; and
wherein the request for the PII is based on an interaction by the user with the field of the interface associated with the relying party.

17. A non-transitory computer-readable storage medium comprising computer-executable instructions for use in sharing personal identifying information (PII) with a relying party, which when executed by at least one processor, cause the at least one processor to:
generate an identity record for a user and store the identity record in a data structure, the identity record including PII for the user;
generate a token specific to the PII included in the identity record for the user and link the token to the identity record in the data structure;
in response to a request for the token from a communication device associated with the user, access the identity record for the user in the data structure, the request including an authentication input for the user captured by the communication device;
authenticate the user based on the accessed identity record and the authentication input included in the request;
in response to authentication of the user, compile a response to the request that includes the token;
transmit the response to the communication device associated with the user, whereby the token included in the response is populated, at the communication device, into an interface associated with a relying party based on a network interaction between the user and the relying party; and
in response to a request for the PII from the relying party, retrieve the PII for the user, based on inclusion of the token in the request from the relying party, and transmit the retrieved PII to the relying party.

18. The non-transitory computer-readable storage medium of claim 17, wherein the computer-executable instructions, when executed by the at least one processor, further cause the at least one processor to identify the identity record for the user in the data structure, in response to the request for the token, based on an identifier for the user included in the request for the token.

19. The non-transitory computer-readable storage medium of claim 17, wherein the computer-executable instructions, when executed by the at least one processor, further cause the at least one processor to authenticate the relying party, in response to the request for the PII from the relying party, prior to transmitting the retrieved PII to the relying party.

20. The non-transitory computer-readable storage medium of claim 19, wherein the computer-executable instructions, when executed by the at least one processor, further cause the at least one processor to identify the token within the identity record based on a field description included in the request for the token, the field description associated with a field of the interface associated with the relying party and soliciting the PII.
